(19) United States
(12) Patent Application Publication
(10) Pub. No.: US 2012/0246942 A1
(43) Pub. Date: Oct. 4, 2012

(54) POWER PRUNER

(75) Inventors: Fangjie Nie, Nanjing (CN); Qi Zhang, Nanjing (CN); Pingbo Shi, Nanjing (CN)

(73) Assignee: CHERVON (HK) LIMITED, Wanchai (HK)

(21) Appl. No.: 13/427,177

(22) Filed: Mar. 22, 2012

(30) Foreign Application Priority Data
Mar. 31, 2011 (CN) 201110080266.8

(51) Int. Cl. A01G 3/033; B26B 15/00

(52) U.S. Cl. 30/247; 30/249; 173/1

(57) ABSTRACT

A power pruner includes a housing, a motor arranged in the housing, a transmission device connected to the motor, a pair of blades and a trigger which is arranged on the housing and used to control the motor. The pair of blades include a fixed blade and a movable blade which is driven by the motor to swing back and forth. The power pruner additionally includes a stroke switch which is arranged on the housing and has at least two statuses wherein the movable blade has a first stroke when the stroke switch is in a first status and a second stroke different from the first stroke when the stroke switch is in a second status.

### RELATED APPLICATION INFORMATION

This application claims the benefit of CN 201110080266.8, filed on Mar. 31, 2011, the disclosure of which is incorporated herein by reference in its entirety.

### BACKGROUND The following generally relates to power pruners and, more particularly, to a power pruner with various strokes.

A power pruner is widely used as a garden tool because of its small shape and easy portability. The power pruner comprises a pair of blades extending out from a housing, wherein one blade is mounted fixedly to the housing, and the other one is connected pivotably to the fixed blade and driven by a motor to swing back and forth. When pulling the trigger, the motor rotates forwardly to drive the movable blade to swing toward the fixed blade, and then an opening formed between the two blades is closed so as to cut the branches. When releasing the trigger, the motor rotates reversely to drive the movable blade to swing away from the fixed blade, and then the opening is again created.

The movable blade of the prior art power pruner has only one stroke, that is to say, it can swing only in one angle range, with the blades either being closed or being opened to the largest angle. The opening of such pruner is designed to be so large that it can cut relatively thicker branches. However, during the actual operation, when cutting relatively thinner branches, the stroke of the movable blade (i.e., the swinging angle) is too large for the thin branches, and the movable blade will swing by a certain angle before contacting and cutting the branches, thus a portion of the stroke is essentially an idle stroke, thereby causing the pruning work to be unnecessarily slowed wasting both time and electricity.

### SUMMARY

In order to resolve the above defect, the subject power pruner provides two strokes, one for thick branches and thin branches. When pruning thick branches, a first stroke is chosen and the movable blade may open to the largest angle; when pruning thin branches, a second stroke is chosen and the movable blade may open to a middle angle position, thereby avoiding the appearance of the idle stroke and efficiently saving the time of the operator and the electrical quantity of the battery.

The subject power pruner comprises a housing, a motor arranged in the housing, a transmission device connected to the motor, a pair of blades and a trigger which is arranged on the housing and used to control the motor, wherein the pair of blades include a fixed blade and a movable blade which is driven by the motor to swing back and forth, wherein power pruner also comprises a stroke switch which is arranged on the housing and has at least two statuses, wherein the movable blade has a first stroke when the stroke switch is in a first status and a second stroke different from the first stroke when the stroke switch is in a second status.

Furthermore, the stroke is the swinging angle of the movable blade, and the movable blade has a first swinging angle when the stroke switch is in the first status and a second swinging angle that is smaller than the first swinging angle when the stroke switch is in the second status.

Furthermore, the housing may be provided with three position sensors therein for sensing the position of the movable blade.

Furthermore, the transmission device may comprise a reduction gear box and a bevel gear transmission mechanism, the bevel gear transmission mechanism comprising a driving gear and a fan-shaped driven gear connected to the movable blade.

Furthermore, the driven gear may be provided with a magnet.

Furthermore, three position sensors may be used to sense the position of the magnet.

Furthermore, the trigger may be arranged on the bottom side of the housing, and the stroke switch may be arranged on the top side of the housing opposite to the trigger.

Furthermore, the stroke switch may be a pushbutton.

Using such a power pruner may therefore include the following steps:

a) when cutting thick branches, setting the stroke switch in the first status, then pulling the switch trigger so that the movable blade moves in the first stroke; and

b) when pruning thin branches, setting the stroke switch in the second status, then pulling the switch trigger so that the movable blade moves in the second stroke.

Regarding the circuit, the power pruner may comprise a microprocessor, a controlling module for controlling rotation direction of a motor, a power source module and a blade position signal acquisition module for acquiring the position of the movable blade, wherein the power pruner also comprises a stroke switch signal acquisition module for acquiring the position of the stroke switch, wherein the stroke switch is switchable between at least two status, and the microprocessor detects the signal from the stroke switch signal acquisition module so as to control the stroke of the movable blade.

The method may also comprise the following steps:

a) pulling the switch trigger whereupon the microprocessor sends a signal to the controlling module to drive the motor to rotate, thereby closing the movable blade;

b) after the microprocessor detects the signal of closed from the blade position signal acquisition module, the microprocessor controlling the motor to stop rotating until releasing the switch trigger;

c) after releasing the switch trigger, the microprocessor detects the signal from the stroke switch signal acquisition module, if the stroke switch is in a large stroke position, the microprocessor drives the motor to rotate in the opposite direction by the controlling module, thereby opening the movable blade until detecting the signal of the largest blade opening position from the blade position signal acquisition module; and d) if the stroke switch is in a small stroke position, the microprocessor drives the motor to rotate in the opposite direction by the controlling module, thereby opening the movable blade until detecting the signal of the middle blade opening position from the blade position signal acquisition module.

### BRIEF DESCRIPTION OF THE DRAWINGS

FIG. 1 is a perspective view of an exemplary embodiment of a power pruner constructed according to the description that follows;

FIG. 2 is a section view showing the inner structure of the power pruner of FIG. 1;

FIG. 3 illustrates a PCB board of FIG. 2; and

FIG. 4 is a circuit block diagram of the power pruner.

### DETAILED DESCRIPTION

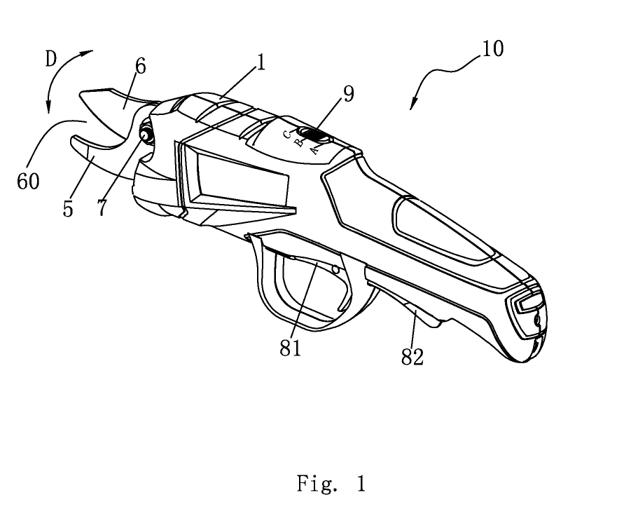

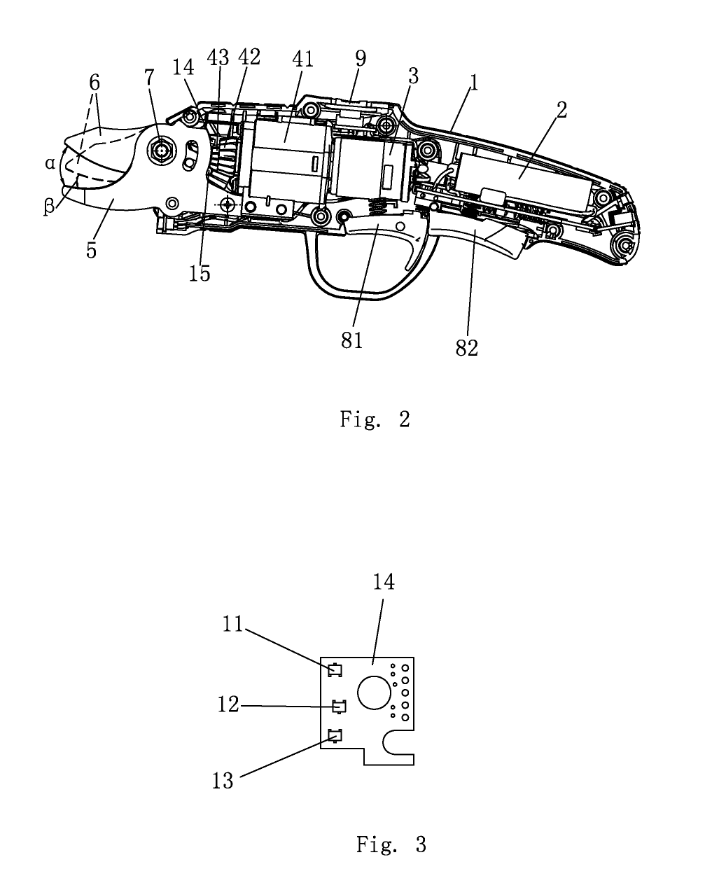

As shown in FIG. 1 and FIG. 2, a power pruner 10 comprises a housing 1 which is composed of two half housings. FIG. 2 particularly illustrates one half housing removed to clearly show the inner structure of the power pruner 10. A battery 2, a motor 3 and a transmission device are arranged within the housing 1. The transmission device comprises a reduction gear box 41 and a bevel gear mechanism, the bevel gear mechanism comprising a driving gear 42 and a driven gear 43 that is fan-shaped. A pair of blades 5 and 6 extends out from the housing 1, wherein the fixed blade 5 is fixedly mounted to the housing 1 by a bolt, and the movable blade 6 is connected pivotably to the fixed blade 5 by a bolt 7. One end of the movable blade 6 is connected fixedly to the driven gear 43, thus it can be driven to be swung back and forth in the direction indicated by an arrow D by the motor 3 so as to close and open an opening 60 formed between the two blades.

A switch trigger 81 and a locking trigger 82 for controlling the motor 3 are arranged on the bottom side of the housing 1. An interlocking relation is formed between the two triggers, that is to say, the switch trigger 81 can be pressed only after the locking trigger 82 is pressed firstly. A stroke switch 9 for controlling the stroke of the movable blade 6 is mounted on the top side of the housing 1 opposite to the switch trigger 81 and takes the form of a pushbutton. The stroke switch 9 can be adjusted among three positions A, B and C shown in the drawings. When the stroke switch 9 is in the position A, the battery 2 cannot provide power to the motor 3, and the switch trigger 81 is ineffective; when the stroke switch 9 is in the position B, the movable blade 6 has a large stroke and can swing in a relatively larger angle range α so as to cut the relatively thicker branches; and when the stroke switch 9 is in the position C, the movable blade 6 has a small stroke and can only swing in a relatively smaller angle range β so as to cut the relatively thinner branches. This is plainly illustrated by the dashed lines shown in FIG. 2. In the present embodiment, the large stroke has an angle a of approximately 30° for cutting the thick branches with a diameter of 15 mm, and the small stroke has an angle β of approximately 12° for cutting the thin branches with a diameter smaller than or equal to 6 mm.

Next, the stroke controlling principle of the power pruner 10 will be described. As shown in FIG. 2 and FIG. 3, a magnet 15 is mounted to the driven gear 43 and moves together with the driven gear 43. A PCB board 14 provided with three position sensors 11, 12 and 13 is fixedly mounted in the housing 1 adjacent to the driven gear 43 for sensing the position of the magnet 15, that is, the position of the movable blade 6. In the exemplary embodiment, the position sensor is a Hall Sensor. When the position sensor 11 detects the magnet 15, it indicates that the movable blade 6 is in the closed position; when the position sensor 12 detects the magnet 15, it indicates that the movable blade 6 is in the largest opening position, that is, the position indicated by the solid line shown in FIG. 2; and when the position sensor 13 detects the magnet 15, it indicates that the movable blade 6 is in the middle opening position, that is, the position indicated by the dashed line shown in FIG. 2.

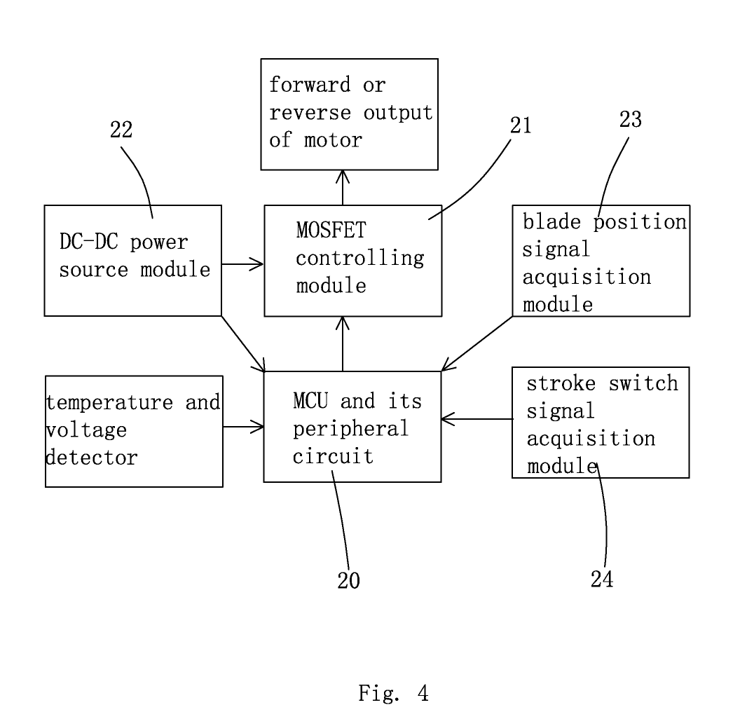

As shown in FIG. 4, the circuit of the power pruner 10 comprises a microprocessor MCU and its peripheral circuit 20, a MOSFET controlling module 21 for controlling the rotation direction of the motor 3, a DC-DC power source module 22, a blade position signal acquisition module 23 functioned by the position sensors 11, 12, 13 and the magnet 15 and a stroke switch signal acquisition module 24 for acquiring the position of the stroke switch 9. When one of the sensors detects the magnet 15, it sends a signal to the blade position signal acquisition module 23, thereby acquiring a signal of the position of the movable blade 6.

When the stroke switch 9 is in the position A, the power source module 22 does not provide power to the microprocessor MCU 20, and the pruner 10 is in a power-off state. When the stroke switch 9 is in the position B or C, the battery 2 provides power to the MCU 20 by the power source module 22, and the pruner 10 is in a power-on state. Then, by pulling the locking trigger 82 and the switch trigger 81, the MCU 20 sends a signal to the MOSFET controlling module 21 to drive the motor 3 to rotate forwardly so that the movable blade 6 swings toward the fixed blade 5 and the opening 60 is closed; when the MCU 20 detects the signal of closed position from the blade position signal acquisition module 23, it controls the motor 3 to stop rotating until the switch trigger 81 is released; after releasing the switch trigger 81, the MCU 20 firstly decide the position of the stroke switch 9 by the stroke switch signal acquisition module 24, if the stroke switch 9 is in the large stroke position B, the MCU 20 drives the motor 3 to rotate reversely by the MOSFET controlling module 21 so that the movable blade 6 swings in the opposite direction and the opening 60 is opened until the signal of the largest opening position from the blade position signal acquisition module 23 is detected. If the stroke switch 9 is in the small stroke position A, the MCU 20 drives the motor 3 to rotate forwardly by the MOSFET controlling module 21 so that the movable blade 6 swings in the opposite direction until the signal of the middle opening position from the blade position signal acquisition module 23 is detected.

In the present embodiment, when the power pruner 10 is in the no-load state, it will take approximately 0.8 seconds to open the movable blade to the largest opening position and take approximately 0.5 seconds to open the movable blade to the middle opening position. Therefore, when cutting the thin branches, it will save approximately 0.6 seconds during one pruning process (including the opening and closing of the opening) if the stroke switch is set to the small stroke position C, which efficiently enhances the working efficiency and resolves the problem that the prior pruner could waste the time and the electrical quantity of the battery when pruning the thin branches.

The above content describes an example embodiment of the invention and discloses a power pruner with two strokes, that is to say, the movable blade has a large stroke and a small stroke, and it can open to the largest opening position or the middle opening position for cutting thick branches and thin branches, respectively. Based on the concept of the invention, in other embodiments, the power pruner may also be designed to have three or more strokes so that the use of the pruner may be further subdivided. Additionally, the sensing method for position of the movable blade is not limited to the above Hall sensor and magnet, and other forms are also feasible, for example, using photoelectric switch or stroke switch. Furthermore, the stroke switch may also use an electronic snapper, which has two positions respectively corresponding to a large stroke and a small stroke, and the stroke switch signal acquisition module is used to acquire the information about the position of the stroke switch.

What is claimed is:

1. A power pruner, comprising:
a housing;
a motor arranged in the housing;
a transmission device connected to the motor;
a pair of blades including a fixed blade and a movable blade which is driven by the motor to swing back and forth; and
a trigger which is arranged on the housing for controlling the motor;
wherein the power pruner further comprises a stroke switch which is arranged on the housing, the stroke switch includes at least two statuses and, while the stroke switch is in a first status, the movable blade has a first stroke, and, while the stroke switch is in a second status, the movable blade has a second stroke which is different from the first stroke.

2. The power pruner of claim 1, wherein the stroke is the swinging angle of the movable blade and, while the stroke switch is in the first status, the movable blade has a first swinging angle, and, while the stroke switch is in the second status, the movable blade has a second swinging angle that is smaller than the first swinging angle.

3. The power pruner of claim 1, wherein the housing is provided with three position sensors for sensing the position of the movable blade.

4. The power pruner of claim 3, wherein the transmission device comprises a reduction gear box and a bevel gear transmission mechanism and wherein the bevel gear transmission mechanism comprises a driving gear and a fan-shaped driven gear connected to the movable blade.

5. The power pruner of claim 4, wherein the driven gear is provided with a magnet.

6. The power pruner of claim 5, wherein the three position sensors are used to sense the position of the magnet.

7. The power pruner of claim 1, wherein the trigger is arranged on the bottom side of the housing and the stroke switch is arranged on the top side of the housing opposite to the trigger.

8. The power pruner of claim 7, wherein the stroke switch is a pushbutton.

9. A method for operating a pruner, wherein the pruner is comprised of a housing; a motor arranged in the housing; a transmission device connected to the motor; a pair of blades including a fixed blade and a movable blade which is driven by the motor to swing back and forth; and a trigger which is arranged on the housing for controlling the motor; wherein the pruner further comprises a stroke switch which is arranged on the housing, the stroke switch includes at least two statuses and, while the stroke switch is in a first status, the movable blade has a first stroke, and, while the stroke switch is in a second status, the movable blade has a second stroke which is different from the first stroke, and wherein the method comprises:
setting the stroke switch in a first position for cutting branches of a first diameter;
pulling the switch trigger so that the movable blade moves in the first stroke;
setting the stroke switch in a second position for cutting branches of a second diameter smaller than the first diameter; and
pulling the switch trigger so that the movable blade moves in the second stroke smaller than the first stroke.

10. A power pruner comprising
a microprocessor;
a controlling module for controlling the rotation direction of a motor;
a power source module; and
a blade position signal acquisition module for acquiring the position of the movable blade;
wherein the power pruner further comprises a stroke switch signal acquisition module for acquiring the position of the stroke switch, wherein the stroke switch is switchable between at least two statuses, and wherein the microprocessor detects the signal from the stroke switch signal acquisition module so as to control the stroke of the movable blade.

11. A method for controlling a power pruner, comprising:
in response to a switch trigger being activated, causing a microprocessor to send a signal to a controlling module to drive a motor to rotate and to thereby close a movable blade with respect to a stationary blade;
in response to the microprocessor receiving from a blade position signal acquisition module a signal indicative of the movable blade being closed with respect to the stationary blade, causing the microprocessor to control the motor to stop rotating;
in response to the switch trigger being thereafter unactivated with a stroke switch being in a large stroke position, causing the microprocessor to drive the motor to rotate in an opposite direction to thereby open the movable blade with respect to the stationary blade until a signal indicative of a largest blade opening position is received by the microprocessor from the blade position signal acquisition module; and
in response to the switch trigger being thereafter unactivated with a stroke switch being in a small stroke position, causing the microprocessor to drive the motor to rotate in an opposite direction to thereby open the movable blade with respect to the stationary blade until a signal indicative of an intermediate blade opening position is received by the microprocessor from the blade position signal acquisition module.
